(19) United States
(12) Patent Application Publication
(10) Pub. No.: US 2010/0105527 A1
(43) Pub. Date: Apr. 29, 2010

(54) Treadmill Deck

(75) Inventor: Fred Johnson, Mukilteo, WA (US)

Correspondence Address: FISH & RICHARDSON P.C., P.O BOX 1022, Minneapolis, MN, 55440-1022, US

(73) Assignee: D & P Products, Inc., Everett, WA (US)

(21) Appl. No.: 12/259,751

(22) Filed: Oct. 28, 2008

(51) Int. Cl. A63B 22/02; B32B 37/00

(52) U.S. Cl. 482/54; 156/300; 156/311

(57) ABSTRACT

A laminated treadmill deck insert includes a wear surface formed of a phenolic impregnated paper laminated to an isocyanate resin bonded MDF insert core less than about 5/16 inch thick. A low moisture content isocyanate resin bonded wood fiber MDF core enables dimensional stability and high internal bonding strength even at reduced insert thicknesses. The deck insert is disposed on a support deck adjacent the upper run of an endless treadmill belt. The insert is provided with wear surfaces on each broad side and is easily removable and reversible to expose the second wear surface.

### FIELD OF THE INVENTION

The invention relates to treadmills, in particular to low friction treadmill decks.

### BACKGROUND

A treadmill is a common exercise device designed to enable walking or running on an endless belt. The belt is trained about a set of rollers, which are powered at different speeds by a motor. The belt is tensioned between the rollers and is supported by a low friction deck extending between the rollers. The rollers, motor and deck are all supported by a rigid frame. Treadmills also commonly include user support handles, control panels and tilt mechanisms.

Treadmill decks generally include a plywood panel or other natural or synthetic fiber panel coated or impregnated with wax, plastic resin or other low friction material. Such decks are commonly a monolithic structure that provides both the structural support for the weight of the user and the low friction wear surface to allow movement of the belt across the deck even during the impulse friction from the user's footsteps.

Some existing belt and treadmill deck combinations produce high motor amperage draw due to friction, causing the deck or motor to wear out faster than the treadmill belt. Replacement of such decks often involves significant disassembly of the treadmill to remove a worn deck from the treadmill frame and install a deck with a fresh wear surface. Due to the cost and service needs of replacing these bulky and heavy monolithic decks, many users consider the treadmill life spent when the deck wears out.

Most commercial treadmills use thick decks (e.g., one inch thick) weighing approximately 4.5 lbs per sq. feet or over 40 pounds total. Such decks are typically wider than the treadmill belt and are mounted to frame rails with trim strips covering the mounting bolts along the longitudinal edges of the treadmill deck.

Accordingly, improvements are sought in the production, wear and replacement of treadmill decks.

### SUMMARY

One aspect of the invention features a thin laminate including a rigid or semi-rigid core having a first broad top face and a second broad bottom face and a phenolic impregnated fibrous layer laminated to each of the first and second broad faces of the core.

In some embodiments, the phenolic impregnated fibrous layer includes kraft paper.

In some cases, the laminate surface has a smooth finish to provide a low friction wear surface.

In some cases, the laminate is less than about 5/16 inch. In some cases, the laminate is less than about ¼ inch thick. In some cases, the laminate is less than about 3/16 inch thick.

In some cases, the laminate includes a phenolic impregnated fibrous layer on both faces of the laminate.

In some cases, the fibrous layer includes multiple sheets of kraft paper. In other cases, the fibrous layer includes a single heavier weight sheet of kraft paper.

One aspect of the invention features a treadmill deck assembly including a rigid deck support having a broad top surface configured to extend at least substantially the width of a treadmill belt. A rigid or semi-rigid deck insert is disposed on the top surface of the deck support and includes a fibrous deck insert core of less than about 5/16 inch, having a first broad top face and a second broad bottom face and a phenolic impregnated fibrous layer laminated to each of the first broad top face and the second broad bottom face of the deck insert core to provide a reduced friction wear surface for the treadmill belt.

In some embodiments, the deck insert core includes isocyanate resin and has a moisture content of less than about four percent prior to lamination with the phenolic impregnated paper. In some embodiments, the deck insert core has a moisture content of less than about four percent after lamination with the phenolic impregnated paper.

In some embodiments, the multiple phenolic impregnated fibrous layers are provided on both faces of the deck insert core. In some embodiments, the deck insert is configured to be mated on either face with the deck support such that the deck insert is reversible to provide a fresh wear surface for the treadmill belt.

Another aspect of the invention features a treadmill deck insert including a rigid or semi-rigid core of medium density fibers bonded with isocyanate resin of less than about 5/16 inch thickness, having a first broad face and a second broad face and a moisture content of less than about four percent. In some content the moisture content is between about three and four percent. In other cases, the moisture content is less than about three percent. A phenolic impregnated fibrous layer is laminated to both broad faces of the core and configured as a wear surface for use with a belt of a treadmill.

In some embodiments, the phenolic impregnated fibrous layer includes kraft paper. The kraft paper has a basis weight of between about 40-80 grams per square meter and is saturated at between about 55-75% with a fast cure phenolic resin. In some cases, the kraft paper has a basis weight of about 47 grams per square meter and is saturated at 65.5% with a fast cure phenolic resin.

In some cases, a second phenolic impregnated fibrous layer is laminated to at least one of the broad faces of the core. In some cases, multiple layers of phenolic impregnated fibrous material are disposed on the first and second broad faces of the substrate.

In some embodiments, the insert has an internal bond strength of between about 180-250 psi. In some embodiments, the insert has an internal bond strength of at least about 200 psi. In some embodiments, the insert has an internal bond strength of at least about 220 psi.

Some embodiments of the invention include a deck insert with one or more of the following features: an internal bond strength of between about 180-250 psi, an internal bond strength of about 180 psi, a thickness of less than about 5/16, a thickness of less than about ¼ inch, a moisture content of less than about 4%, a moisture content of about 3%; and a surface finish of between about 6-20 Ra.

Another aspect of the invention features a treadmill including a frame having first and second opposed ends, a first powered roller disposed at the first frame end, and a second roller disposed at the second frame end. A treadmill deck having an upper broad surface and a lower broad surface and supported on the frame between the first and second rollers and continuous belt is trained about the first and second rollers over the upper broad surface of the deck. A deck insert is disposed on the upper broad surface of the deck adjacent the belt, the insert including a phenolic resin impregnated kraft paper layer laminated to first and second broad surface of a medium density fiber isocyanate resin bonded core having a moisture content of less than about 4% and a thickness of less than about 5/16 inch.

In some embodiments, the treadmill further includes a second resin impregnated kraft paper layer laminated to one of the first and second broad surface of the core to provide low friction wear surface.

In some embodiments, the deck insert is configured to be readily removable, reversible and reinstallable between the belt and deck support without substantial disassembly of the treadmill.

In some embodiments, the insert is less than about ¼ inch thick. In other cases, the deck is between about ¼ inch thick and 5/16 inch thick.

Another aspect of the invention features a method of manufacturing a treadmill deck insert including providing a rigid or semi-rigid fibrous substrate having a first broad surface and a second broad surface and a moisture content of less than about four percent, saturating kraft paper with basis weight of between about 40-80 grams per square meter to between about 55-75% with phenolic resin, disposing a first layer of the phenolic saturated kraft paper on the first broad surface of the substrate, disposing a second layer of the phenolic saturated kraft paper on the second broad surface of the substrate, and laminating the paper layers to the substrate at high temperature and pressure to form a deck insert having a low friction wear surface on opposite broad faces.

In some applications, the method includes disposing an additional layer of phenolic saturated kraft paper on one of the first and second broad surfaces of the substrate. In some applications, the method includes disposing additional layers of phenolic saturated kraft paper on both surfaces.

In some applications, the laminating is performed at about 200 bars pressure and about 170 C temperature for about 60 seconds.

In some applications, the method includes forming countersunk holes along the periphery of the two opposite faces of the insert.

In some applications, the laminated deck insert is less than about 5/16 inch thick.

In some applications, the laminated deck insert is about ¼ inch thick, has an internal bond strength of about 200 psi and a surface finish of between about 6-20 Ra micro inches.

### DESCRIPTION OF DRAWINGS

FIG. 1 is a perspective view of one treadmill embodiment.

FIG. 2 is partial perspective view of a deck assembly embodiment.

FIG. 3 is a cross-sectional view of the treadmill of FIG. 1 taken along line 3-3.

FIG. 4 is a flow chart showing a method of making a treadmill deck insert.

Like reference symbols in the various drawings indicate like elements.

### DETAILED DESCRIPTION

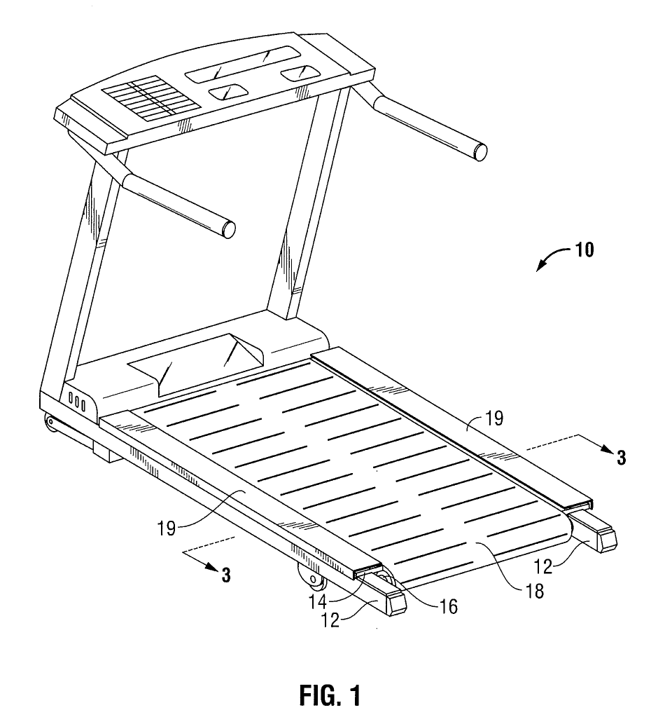

With reference to FIG. 1, one embodiment of a treadmill 10 includes a rigid frame 12 supporting a treadmill deck assembly 14. First and second rollers 16 are supported by frame 12 at either end of deck assembly 14. Generally, one of the rollers 16 is powered by a variable speed motor (not shown). An endless belt 18 is trained and tensioned about the rollers over deck assembly 14.

Deck assembly 14 is wider than belt 18, or at least substantially as wide as belt 18, and is supported and fastened on frame 12. Trim panels 19 cover the fasteners and portion of deck assembly that extends beyond the width of belt 18 and can provide a resting footing location for the treadmill user.

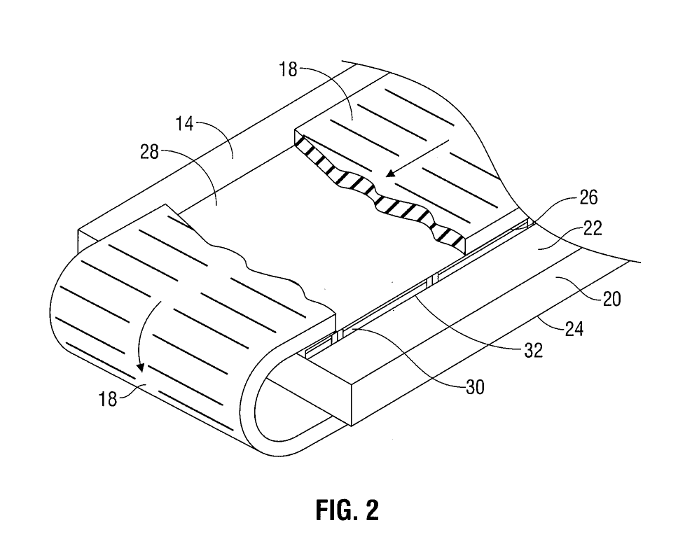

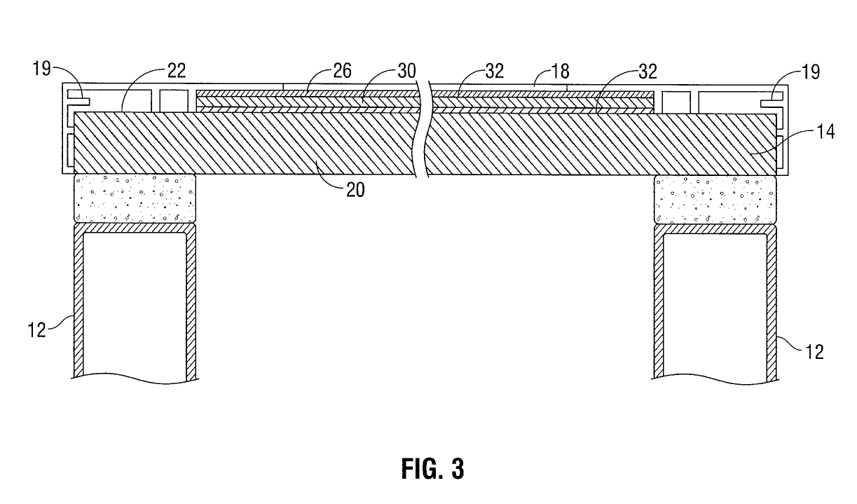

With reference to FIGS. 2-3, treadmill deck assembly 14 includes a deck support 20 beneath a deck insert 26 that serves as a low friction wear surface 28 for belt 18. Deck support 20 includes a first top surface 22 on a top side. Deck support 20 can be plywood, medium density fiberboard (MDF), metal, plastic or other material suitable to support the weight and impact of a runner's footsteps.

Treadmill deck insert 26 is positioned on the first broad surface of deck support 20 with wear surface 28 adjacent belt 18. Insert 26 comprises an insert core 30 and a resin impregnated paper layer 32 laminated across a first broad surface 34 on a top side of core 30 and a second broad surface on a bottom side of core 30.

Lamination of core 30 and paper layers 32 is performed in a high temperature, high pressure laminating press. It was determined through experimentation that standard MDF and plywood materials, which typically have a moisture content of 5-6% or higher, were not suitable for use in thin laminates with phenolic impregnated paper due to delamination and dimensional stability concerns.

It was determined through significant continued experimentation that use of an isocyanate resin MDF material with a reduced moisture content of about 3-4% or less resulted in durable lamination of a phenolic impregnated paper layer 32 to a fiberboard core 30 with good wear surface characteristics. This was particularly significant in enabling lamination with very thin MDF cores 30 of about ¼ inch or less.

Another embodiment of deck insert 26 comprises multiple phenolic saturated kraft paper layers 32 applied to both sides of core 30. Paper layer 32 has a basis weight of about 40-80 grams per square meter and is saturated or impregnated to 55-75% with a fast cure phenolic resin. One particular embodiment includes kraft paper having basis weight of about 47 grams per square meter that is saturated to about 65.5% with phenolic resin.

In some cases, core 30 is less than about 5/16 inch thick, or less than about ¼ inch thick, and has a moisture content of less than about 4% or of about 3%.

In some embodiments, a second resin impregnated paper layer is provided on a second broad surface on a bottom side of core 30 such that insert 26 is reversible to provide a fresh wear surface 28. In some embodiments, deck insert 26 can include more than one sheet of impregnated paper 32 on one or more broad surfaces of insert 26. In some cases, a heavier basis weight single layer of kraft paper is used.

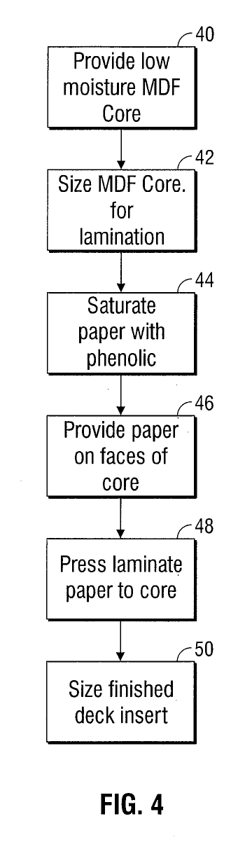

With reference to FIG. 4, a method of making deck insert 20 includes providing an isocyanate resin MDF deck insert core 30 having a moisture content of less than about 4%. (40) Low moisture content of the core is preferably preserved prior to lamination as moisture content greater than about 3-4% causes paper layer 32 to delaminate from core 30 in the press. For example, core 30 can be enclosed in a sealed packaging to exclude ambient moisture from increasing the effective moisture content of core 30. The core is then removed from the scaled packaging just prior to lamination.

Deck core 30 is formed from an MDF panel, which is refined wood fibers and isocyanate resin formed into a matte and press cured into uniform panels at high pressure (e.g., 900 psi) and high temperature (e.g., 365 degree Fahrenheit). The moisture of the wood fines and curing parameters arc controlled to provide a finished MDF panel having a moisture content of less than about 4%, and preferably about 3%.

One suitable MDF core 30 has the following properties: a moisture content between 3-4%, a fiber density of about 50-52 lbs per cubic foot, a resin percentage of about 3%, a core thickness of about ¼ inch with an internal bond of 180-250 psi. For even thinner deck embodiments, fiber density of about 55 lbs per cubic foot and about 4% resin can be used to obtain relatively high internal bond values (about 250 psi) to prevent core and face delamination.

The method includes sizing MDF deck inset core 30 to fit in a laminating press. (42) The laminating press can accommodate sufficient material for one or more finished deck inserts 26 at a time. (42)

The method includes saturating kraft paper with phenolic resin to form phenolic impregnated paper layer 32. (44). The kraft paper has a basis weight of between about 40-80 grams per square meter and is saturated at 55-75% with a fast cure phenolic resin. In a particular embodiment, the kraft paper has a basis weight of 47 grams per square meter and is saturated to 65.5% by weight with a fast cure phenolic resin. A suitable phenolic saturated kraft paper is available from Arclin Surfaces of Tacoma, Wash., including kraft paper available from Nordic Paper of Sweden and phenolic resin number R3485 or R3486.

One ore more layers of phenolic impregnated paper 32 are then provided on both faces of MDF core 30 to form a prelaminate lay-up. (46) The paper and core lay-up is placed in a high speed laminating press and laminated at high temperature and pressure. (48). The phenolic saturated kraft paper layers 32 and isocyanate MDF core 30 are thus thermofused to produce a laminate with an internal bond value of about 200 psi. This is a significant increase over the internal bond values of about 140 psi for existing urea formaldehyde MDF panels or thicker and higher moisture content MDF panels. By closely controlling the moisture content in the precursor isocyanate MDF panels, a suitable thin deck insert 26 was achieved using a press cycle time of 60 seconds, at 200 bars pressure and 338 degrees Fahrenheit. The laminated core and paper panel is then finish cut into individual insert decks 26. (50).

The laminating press includes stainless hard chromed surfaced plates with a 6-20 Ra micro inch finish to impart a smooth finish to wear surface 28 of the exposed faces of deck insert 26. This has been determined to be sufficiently smooth to enable a polyester treadmill belt to glide over wear surface 28 under the intense repeated pressure during footsteps of a runner on deck assembly 14. The phenolic resin on the paper surface provides a suitable taber abrasive value resulting in a relatively long useful life comparable to the thicker phenolic coated panels currently used in commercial treadmills. The thin deck insert 26 provides a low friction surface with reduced amperage draw. A paraffin, carnauba or polyolefin based wax can also be added to the wear surface of deck insert 26 or the underside of belt 18 for lubrication purposes.

The thin deck insert 26 is mated during treadmill assembly to a sub support deck 20 made of plywood, particleboard, MDF, plastic, steel or other ferrous or non ferrous materials. The thin insert deck 26 need not be as wide as the underlying support deck 20. This provides a significant cost of manufacturing advantage over existing monolithic phenolic decks. Furthermore, in contrast to the bulky, heavy prior art decks, a thin, e.g. ¼ inch, insert deck 26 weighs a mere one pound per square foot. This provides significant savings in handling, shipping and installation of replacement deck inserts. Some thin insert embodiments are reversible to provide two useful wear surfaces 28.

Insert deck 26 can be mechanically fastened along its longitudinal periphery with countersunk fasteners (e.g., screws) to an underlying deck support 20. In alternative embodiments, deck support 30 and deck insert 20 are formed with complementary interlocking features. For example, deck support 20 can include a recess to retain deck insert 26. Other fastening means such as touch fasteners, rivets, adhesives and the like can also be used. Deck support 20 is fastened to frame 12 of treadmill 10 with bolts or the like, which are then covered by trim panels 19. Trim panels 19 can also cover the countersunk fastenings securing thin deck 26 to deck support 20. Alternatively, the countersunk fastenings can be located under the periphery of belt 18.

Accordingly, deck insert 26 is readily reversible or interchangeable simply by removal of trim panels 19 and deck insert fasteners to enable removal and reinstallation of the insert between belt 18 and deck support 20. Thus, in many cases, belt 18 need not be loosened nor deck support 20 removed to provide a fresh wear surface 28 under belt 18. This provides a significant savings of time and service expense in maintaining treadmill 10.

Accordingly, various embodiments provide advantages including at least simplicity, reduced production costs, reduced shipping cost and reduced replacement labor and costs.

A number of embodiments of the invention have been described. Nevertheless, it will be understood that various modifications may be made without departing from the spirit and scope of the invention. For example, other fabrics or nonwoven materials may be used in place of kraft paper and non-wooden fibers may be used to form the insert core. Accordingly, other embodiments are within the scope of the following claims.

What is claimed is:

1. A treadmill deck assembly comprising:
a rigid deck support having a broad top surface configured to extend at least substantially the width of a treadmill belt;
a rigid or semi-rigid deck insert disposed on the top surface of the deck support and comprising:
a fibrous deck insert core of less than about 5/16 inch, having a first broad top face and a second broad bottom face;
a phenolic impregnated fibrous layer laminated to the first and second broad face of the deck insert core to provide a reduced friction wear surface for the treadmill belt.

2. The deck assembly of claim 1, wherein the deck insert core includes isocyanate resin and has a moisture content of less than about four percent prior to lamination with the phenolic impregnated paper.

3. The deck assembly of claim 1, further comprising multiple phenolic impregnated fibrous layers on both faces of the deck insert core.

4. The deck assembly of claim 1, wherein the deck insert is configured to be mated on either face with the deck support such that the deck insert is reversible to provide a fresh wear surface for the treadmill belt.

5. A treadmill deck insert comprising:
a rigid or semi-rigid core of medium density fibers bonded with isocyanate resin, the core having a thickness of less than about 5/16 inch, having a first broad face and a second broad face and a moisture content of less than about four percent;
a phenolic impregnated fibrous layer laminated to each of the first and second broad faces of the core and configured as a wear surface for use with a belt of a treadmill.

6. The treadmill deck insert of claim 5, wherein the phenolic impregnated fibrous layer includes kraft paper.

7. The treadmill deck insert of claim 6, wherein the kraft paper has a basis weight of between about 40-80 grams per square meter and is saturated to between 55-75% by weight with a fast cure phenolic resin.

8. The treadmill deck insert of claim 7, wherein the kraft paper has a basis weight of 47 grams per square meter and is saturated to 65.5% by weight with a fast cure phenolic resin.

9. The treadmill deck insert of claim 8, comprising multiple layers of phenolic impregnated fibrous material on the first and second broad faces of the substrate.

10. The treadmill deck insert of claim 5, wherein the insert has an internal bond strength of between about 180-250 psi.

11. A treadmill comprising:
a frame having first and second opposed ends;
a first powered roller disposed at the first frame end;
a second roller disposed at the second frame end;
a treadmill deck having an upper broad surface and a lower broad surface and being supported on the frame between the first and second rollers;
a continuous belt trained about the first and second rollers over the upper broad surface of the deck;
a deck insert disposed on the upper broad surface of the deck adjacent the belt, the insert comprising a phenolic resin impregnated kraft paper layer laminated to first and second broad surfaces of a medium density fiber isocyanate resin bonded core having a moisture content of less than about 4% and a thickness of less than about 5/16 inch.

12. The treadmill of claim 11, further comprising a second resin impregnated kraft paper layer laminated to one of the first and second broad surfaces of the core.

13. The treadmill of claim 10, wherein the deck insert is configured to be readily removable, reversible and reinstallable between the belt and deck support without substantial disassembly of the treadmill.

14. The treadmill of claim 10, wherein the insert is less than about one quarter inch thick.

15. A method of manufacturing a treadmill deck insert comprising the steps of:
providing a rigid or semi-rigid fibrous substrate having a first broad surface and second broad surface and a moisture content of less than about four percent;
saturating kraft paper to between about 55-75% by weight with phenolic resin;
disposing a first layer of the phenolic saturated kraft paper on the first broad surface of the substrate;
disposing a second layer of the phenolic saturated kraft paper on the second broad surface of the substrate;
laminating the paper layers to the substrate at high temperature and pressure to form a deck insert having a low friction wear surface on opposite broad faces of the insert.

16. The method of claim 15, further comprising disposing an additional layer of phenolic saturated kraft paper on one of the first and second broad surfaces of the substrate.

17. The method of claim 15, wherein the laminating is performed at about at 200 bars pressure and 170 C temperature for about 60 seconds.

18. The method of claim 15, further comprising forming countersunk holes along an the periphery of two opposite sides of the insert.

19. The method of claim 15, wherein the laminated deck insert is less than about 5/16 inch thick.

20. The method of claim 15, wherein the laminated deck insert is about ¼ inch thick, has an internal bond strength of about 200 psi and a surface finish of between about 6-20 Ra micro inches.
